(19) United States
(12) Patent Application Publication
(10) Pub. No.: US 2020/0048580 A1
(43) Pub. Date: Feb. 13, 2020

(54) Gemini-Like and Oligomeric-like Surfactant Compositions

(71) Applicant: Huntsman Petrochemical LLC, The Woodlands, TX (US)

(72) Inventors: George A. Smith, Conroe, TX (US); Heather Byrne, Houston, TX (US); R. Scott Tann, Sugar Land, TX (US)

(21) Appl. No.: 16/340,416

(22) PCT Filed: Jan. 16, 2018
(86) PCT No.: PCT/US2018/013847

§ 371 Date: Apr. 9, 2019

Related U.S. Application Data
(60) Provisional application No. 62/446,684, filed on Jan. 16, 2017.

(51) Int. Cl. C11D 1/83; C11D 1/645; C11D 1/65; C11D 1/835; C11D 10/04

(52) U.S. Cl. CPC C11D 1/83; C11D 1/645; C11D 1/123; C11D 1/835; C11D 10/045; C11D 1/65

(57) ABSTRACT

A surfactant composition comprising a nonionic surfactant and a supra-amphiphile comprising one or more gemini-like and/or oligomeric-like surfactants, and a method of producing such.

### CROSS REFERENCE TO RELATED APPLICATIONS

This application claims benefit to U.S. Provisional Application Ser. No. 62/446,684, filed Jan. 16, 2017, the entire disclosure of which are incorporated herein by reference.

### STATEMENT REGARDING FEDERALLY SPONSORED RESEARCH OR DEVELOPMENT

Not applicable.

### FIELD

The present disclosure generally relates to a water soluble surfactant composition comprising a nonionic surfactant and a supra-amphiphile comprising one or more gemini-like and/or oligomeric-like surfactants. The presently disclosed surfactant composition may be used in a variety of applications, such as in a detergent formulation.

### BACKGROUND

Gemini surfactants consist of two monomeric surfactants covalently connected at or near their head groups, neutralized with oppositely charged counterions. Oligomeric surfactants are made up of three or more identical or nearly identical monomeric surfactants covalently connected at or near the head groups, all of which are neutralized with oppositely charged counterions.

Gemini and oligomeric surfactants have long been known to exhibit superior physicochemical properties compared to corresponding traditional single-chain surfactants. Despite their superior physicochemical properties, gemini and oligomeric surfactants have not seen wide commercial acceptance because they require tedious covalent synthesis and complicated purification in order to be produced. See Zhu L., Tang Y., and Wang Y (2016) Constructing Surfactant Systems with the Characteristic of Gemini and Oligomeric Surfactants Through Noncovalent Interaction. J Surfact Deterg 19:237-247; See also Bunton C A, Robinson L, Sckaak J., Stam M F (1971) Catalysis of Nucleophilic Substitutions by Micelles of Dicationic Detergents. J Org Chem, 36:2346-2350, and Zana R. (2002) Dimeric and Oligomeric Surfactants. Behavior at Interfaces and in Aqueous Solution: A Review. Advances in Colloid and Interface Science 97:205-253, each of which is hereby incorporated by reference herein in its entirety.

In response to an increasing desire to exploit the physicochemical properties of gemini and oligomeric surfactants without the rigors of their covalent synthesis, new methods were developed to form similar structures using noncovalent interactions, such as hydrogen bonding, metal-ligand coordination, host-guest recognition, and electrostatic attraction. Surfactants comprising two amphiphilic moieties formed via noncovalent interactions are referred to as “gemini-like surfactants”. Surfactants comprising three or more identical or nearly identical amphiphilic moieties formed using noncovalent interactions are referred to as “oligomeric-like surfactants”. Such gemini-like surfactants and oligomeric-like surfactants are collectively referred to as supra-amphiphiles.

One of the most convenient approaches to forming gemini-like and oligomeric-like surfactants (also referred to as “gemini salts” or “pseudogemini surfactants” and “oligomeric salts” or “psuedooligomeric surfactants”, respectively) is by way of electrostatic attraction in which one or more of a bola-type organic acid, base, or salt is combined with oppositely charged single-chain surfactants to form a salt therefrom. It is believed that the electrostatic attraction between the opposite charges of the one or more bola-type organic acid, base, or salt and the oppositely charged single chain surfactants results in a gemini-like or oligomeric-like structure having similar properties as covalently produced gemini and oligomeric surfactants.

FIG. 1 is a representative illustration highlighting the differences between gemini/oligomeric surfactants and gemini-like/oligomeric-like surfactants on a very basic level. As illustrated, the gemini/oligomeric surfactants have covalent bonds connecting the heads of each amphiphilic moiety and the gemini-like/oligomeric-like surfactants are formed by electrostatic interaction between, for example, the cationic groups of the bola-type organic base and the anionic single-tail surfactants.

Similar to their namesake, gemini-like and oligomeric-like surfactants have not seen widespread commercial acceptance due to their limited water solubility and tendency to form multi-walled lamellar droplets and vesicles. Therefore, it would be advantageous to provide a stable, substantially water soluble composition comprising one or more gemini-like and/or oligomeric-like surfactants.

### FIGURES

FIG. 1 is a representative illustration of gemini/oligomeric surfactants and gemini-like/oligomeric-like surfactants.

FIG. 2 is a representative illustration of the pH and solubility for various concentrations of ethylene diamine added to an aqueous solution containing 10 wt. % low 2-phenyl LAS.

FIG. 3 is a representative illustration of the viscosity and solubility for various concentrations of ethylene diamine added to an aqueous solution containing 7.5 wt. % low 2-phenyl LAS and 2.5 wt % of a nonionic surfactant.

FIG. 4 is a representative illustration of the viscosity for various concentrations of ethylene diamine added to an aqueous solution containing 7.5 wt. % low 2-phenyl LAS and 2.5 wt % of a nonionic surfactant.

FIG. 5 is a graphical depiction of the viscosities of various amine/LAS salts in an aqueous solution comprising a nonionic surfactant.

FIG. 6 is a graphical depiction of the detergency results of various amine/LAS salts in an aqueous solution containing a nonionic surfactant.

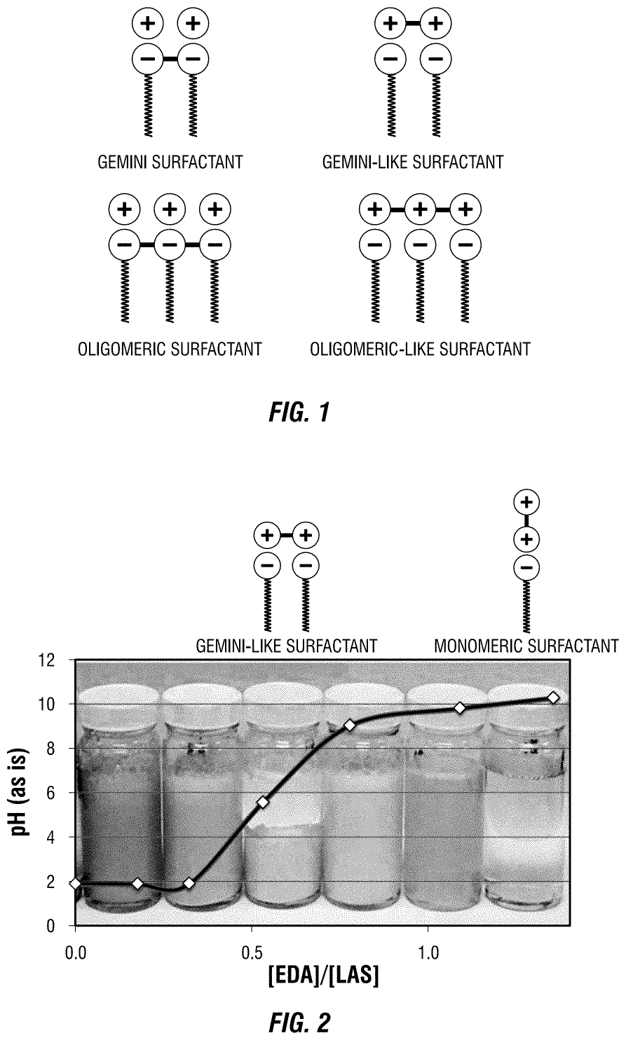

### DETAILED DESCRIPTION

Before explaining at least one embodiment of the present disclosure in detail, it is to be understood that the present disclosure is not limited in its application to the details of construction and the arrangement of components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

In addition, the phrase “at least one of X, Y, and Z” will be understood to include X alone, Y alone, and Z alone, as well as any combination of X, Y, and Z. Likewise, the phrase “at least one of X and Y” will be understood to include X alone, Y alone, as well as any combination of X and Y. Additionally, it is to be understood that the phrase “at least one of” can be used with any number of components and have the similar meanings as set forth above.

The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the term “and combinations thereof” when used with the phrase “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the terms “% by weight”, “wt. %”, “weight percentage”, or “percentage by weight” are used interchangeably.

The phrase “substantially free” shall be used herein to mean present in an amount less than 1 weight percent, or less than 0.1 weight percent, or less than 0.01 weight percent, or alternatively less than 0.001 weight percent, based on the total weight of the referenced composition.

Additionally, the terms “multi-functional base”, “bolaform organic base”, and “bola-type organic base” are used interchangeably to refer to a compound having at least two proton acceptors spaced apart by one or more atoms. Likewise, the terms “multi-functional acid”, “bolaform organic acid”, and “bola-type organic acid” are used interchangeably to refer to a compound having at least two proton donors spaced apart by one or more atoms.

“Low 2-phenyl linear alkylbenzene sulfonate” as used herein refers to linear alkylbenzene sulfonate produced using a hydrogen fluoride process as would be known to a person of ordinary skill in the art.

“Water-soluble, as used herein, means substantially isotropic without significant liquid crystal formation in deionized water at 20° C.

The term “supra-amphiphile” is used herein to refer to a salt of a multi-functional amine and an anionic surfactant or, alternatively, a salt of a cationic surfactant and a multi-functional acid, both of which are produced via noncovalent interactions, specifically electrostatic interaction, and are commonly referred to as gemini-like and/or oligomeric-like surfactants.

According to one aspect, the present disclosure is directed to a surfactant composition comprising (i) a nonionic surfactant, and (ii) at least one supra-amphiphile.

In one embodiment, the at least one supra-amphiphile comprises a salt of an anionic surfactant and a multi-functional amine.

The anionic surfactant can comprise one or more single tail surfactants selected from, for example but without limitation, a linear alkylbenzene sulfonate, an alkyl ether sulfate, an alkyl sulfate, a secondary alkane sulfonate, an olefin sulfonate, a sulfosuccinate, a phosphate esters, a soap, or mixtures thereof.

In one particular embodiment, the anionic surfactant comprises a linear alkylbenzene sulfonate represented by formula (I):

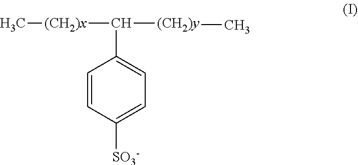

wherein x is less than or equal to 11 and y is greater than or equal to 0 with the proviso that the sum of x and y is greater than or equal to 7 but less than or equal to 11.

Non-limiting examples of the linear alkylbenzene sulfonate include decylbenzene sulfonate, dodecylbenzene sulfonate, tridecylbenzene sulfonate, undecylbenzene sulfonate, monoalkylbenzene sulfonate, alkylbenzene sulfonate, C₁₀₋₁₄ alkyl derivatized benzene sulfonate, monoalkylbenzene sulfonate, or mixtures thereof.

In one embodiment, the anionic surfactant is a low 2-phenyl linear alkyl benzene sulfonate. A commercially available example of low 2-phenyl linear alkyl benzone sulfonate is BIO-SOFT® S-120 from Stepan Company, Northfield, Ill., USA.

In one embodiment, the anionic surfactant comprises an alkyl ether sulfate represented by formula (II):

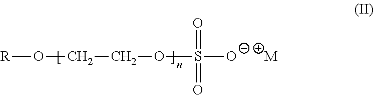

wherein R is a C₈-C₂₄ alkyl (linear or branched, saturated or unsaturated) or mixtures thereof; n is in a range of from 1 to 12; and M⁺ is representative of one of the amine functional groups of the multi-functional amine as described herein. Non-limiting examples include sodium laureth sulfate (R=C₁₂ alkyl, n=1-3), ammonium laureth sulfate (R=C₁₂ alkyl, n=1-3), and sodium trideceth sulfate (R=C₁₃ alkyl, n=1-4).

In another embodiment, the anionic surfactant comprises an alkyl sulfate represented by formula (III):

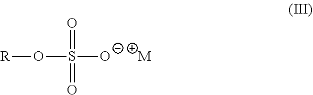

wherein R is a C₈-C₂₄ alkyl (linear or branched, saturated or unsaturated) or mixtures thereof and M⁺ is representative of one of the amine functional groups of the multi-functional amine as described herein. Non-limiting examples include sodium lauryl sulfate (R=C12 alkyl) and ammonium lauryl sulfate (R=C12 alkyl).

In still another embodiment, the anionic surfactant comprises an olefin sulfonate represented by formula (IV):

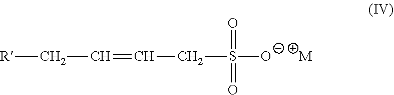

wherein R′ is a C₈-C₁₈ alkyl (linear or branched, saturated or unsaturated) or mixtures thereof and M⁺ is representative of one of the amine functional groups of the multi-functional amine as described herein.

The multi-functional amine comprises a compound having at least two amines selected form the group consisting of a primary amine, secondary amine, tertiary amine, quaternary amine, or a combination thereof. In one embodiment, the multi-functional amine is a compound selected from the group consisting of a di-functional amine, tri-functional amine, tetra-functional amine, penta-functional amine, hexa-functional amine, or combinations thereof.

Non-limiting examples of the multi-functional amines include, but are not limited to, (poly)ethylene polyamines such as ethylene diamine (“EDA”), diethylene triamine (“DETA”), triethylene tetramine (“TETA”), and tetraethylene pentamine (“TEPA”),; (poly)propylene polyamines such as 1,3-propylenediamine, dipropylene diamine, tripropylene tetramine, and dimethylaminopropylamine (DMAPA); polyether diamines such as bis(aminoethyl ether), dipropylglycol diamine, triethyleneglycol diamine, and polypropyleneglycol diamine; polyether triamines; di-functional amine catalysts; tri-functional amine catalysts; or combinations thereof.

In one particularly preferred embodiment, the multi-functional amine is at least one of a (poly)ethylene polyamine and a (poly)propylene polyamine. The (poly)ethylene polyamine can be selected from ethylene diamine, diethylene triamine, riethylene tetramine, tetraethylene pentamine, dimethylaminopropylamine, or combinations thereof.

In one embodiment, the multi-functional amine is a polyether diamine having a formula (V), (VI), or (VII):

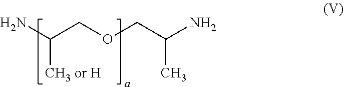

wherein “a” ranges from about 2 to about 100;

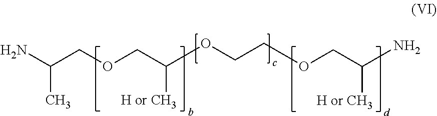

wherein c ranges from about 2 to about 40 and the sum of b and d ranges from about 1 to about 10;

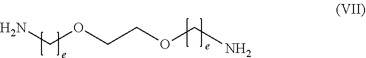

wherein e ranges from about 2 to about 3.

Commercially available polyether diamines include the JEFFAMINE® D, ED and EDR amines, including, but not limited to, JEFFAMINE® D-230, D-400, D-2000, D-4000, ED-600, ED-900, ED-2003, EDR-148 and EDR-176 amines, available from Huntsman Petrochemical LLC, The Woodlands, Tex., USA.

Additional polyether diamines include alpha,alpha′-(oxydi-2,1-ethanediyl)bis(omega-(aminomethylethoxy)) commercially available as JEFFAMINE® XTJ-511 from Huntsman Petrochemical LLC, The Woodlands, Tex., USA as well as blends of amines that contains triethyleneglycoldiamine along with partially aminated compounds and higher oligomers—a commercial example of which is JEFFAMINE® XTJ-512 also available from Huntsman Petrochemical LLC.

In another embodiment, the multi-functional amine is a polyether triamine having a formula (VIII):

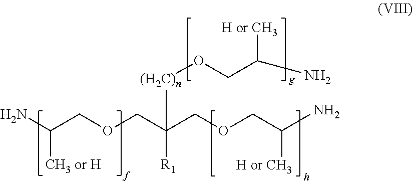

wherein R₁ is hydrogen, methyl, or ethyl; n is 0 or 1; and the sum of f, g, and h ranges from about 1 to about 100.

Commercially available polyether triamines include the JEFFAMINE® T-series amines, including, but not limited to, JEFFAMINE® T-403, T-3000 and T-5000 amines, available from Huntsman Petrochemical LLC, The Woodlands, Tex., USA.

In one embodiment, the multi-functional amine is a di-functional amine catalyst having a formula (IX), (X), (XI), (XII), (XIII), or (XIV):

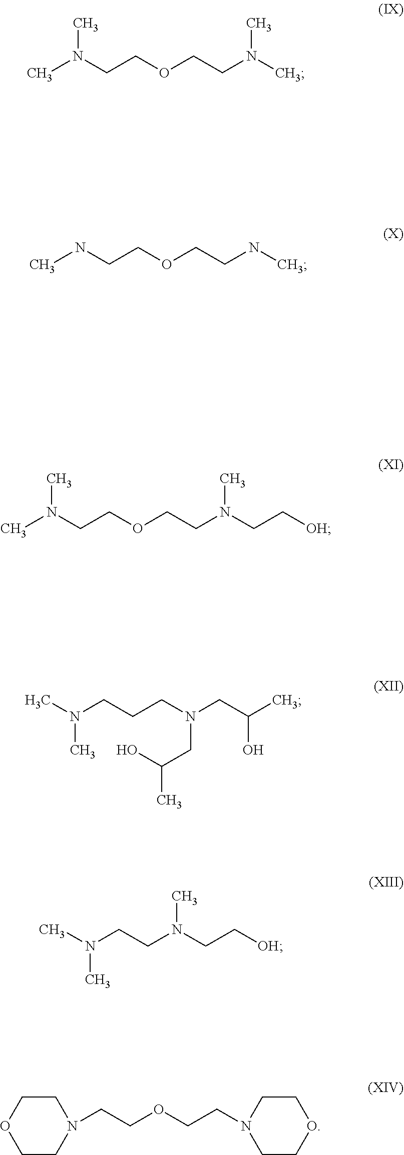

Commercially available di-functional amine catalysts include the following JEFFCAT® amine catalysts from Huntsman Petrochemical LLC, The Woodlands, Tex., USA: JEFFCAT® ZF-20, ZF-10, DPA, Z-130, Z-110, and DMDEE.

In another embodiment, the multi-functional amine is a tri-functional amine catalyst having a formula (XV), (XVI), (XVII), or (XVIII):

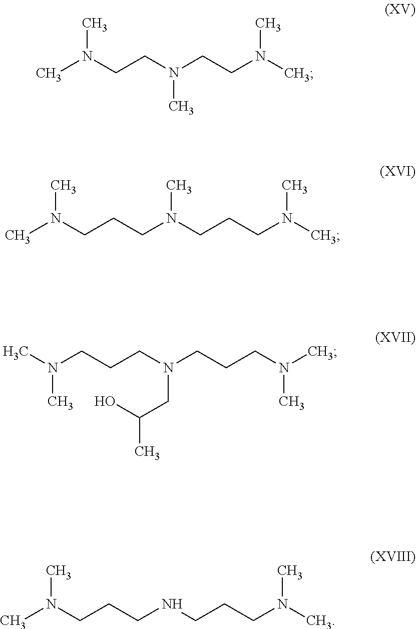 [SMILES: CN(C)CCN(C)CCN(C)C ; CN(C)CCCN(C)CCCN(C)C ; CC(O)CN(CCCN(C)C)CCCN(C)C ; CN(C)CCCNCCCN(C)C]

Commercially available tri-functional amine catalysts include the following JEFFCAT® amine catalysts from Huntsman Petrochemical LLC, The Woodlands, Tex., USA: JEFFCAT® PMDETA, ZR-40, ZR-50, and Z-130.

The ratio of the multi-functional amine to anionic surfactant is such that the resulting solution is substantially neutralized so as have a pH between about 5 to about 9.5, or between about 6 and about 8, more preferably about 7.

For example, if the anionic surfactant is a linear alkylbenzene sulfonate and the multi-functional amine is a polyether diamine or ethylene diamine, then a molar ratio of about 0.5 of the multi-functional amine to anionic surfactant (corresponding to two anionic surfactant molecules for every diamine molecule) to about 0.8 of the multi-functional amine to anionic surfactant will result in a neutralized solution having a pH in a range of from about 5 to about 9.5, or from about 6 to 8, more preferably about 7. Likewise, if the anionic surfactant is a linear alkylbenzene sulfonate and the multi-functional amine is a polyether triamine or diethylene triamine, then a molar ratio of 0.33 of the multi-functional amine to anionic surfactant (corresponding to three anionic surfactant molecules for every triamine molecule) to 0.8 of the multi-functional amine to anionic surfactant will result in a neutralized solution having a pH in a range of from about 5 to about 9.5, or from about 6 to about 8, more preferably about 7.

In another embodiment, the supra-amphiphile is a salt of a cationic surfactant with a multi-functional acid.

The cationic surfactant can be single tail cationic surfactants selected from primary amine salts, quaternary ammonium salts, ethoxylated amines, or mixtures thereof.

Examples of quaternary ammonium salt and methods for preparing the same are described in the following patents, which are hereby incorporated by reference, U.S. Pat. Nos. 4,253,980, 3,778,371, 4,171,959, 4,326,973, 4,338,206, and 5,254,138

The multi-functional acid can be dimerized fatty acids, maleic acid, fumaric acid, citric acid, or mixtures thereof.

The ratio of cationic surfactant to multi-functional acid is such that the resulting solution is neutralized so as have a pH between about 5 to about 9.5, or between about 6 and about 8, or about 7. For example, if the cationic surfactant is a quaternary ammonium salt and the multi-functional acid is a maleic acid, then a molar ratio of multi-functional acid to cationic surfactant of about 0.5 (corresponding to two cationic surfactant molecules for every multi-functional acid molecule) to about 0.8 will result in a neutralized solution having a pH between about 5 to about 9.5, or between about 6 and about 8, or about 7.

The nonionic surfactant can be selected from a nonylphenol ethoxylate, a fatty alcohol ethoxylate, a methyl ester ethoxylate, an alkyl polyglucoside, an alkanolamide, a vegetable oil ethoxylate, or a combination thereof.

In one embodiment, the nonionic surfactant has a hydrophile-lipophile balance in a range of from about 10 to about 14, or from about 10 to about 13.

Non-limiting examples of the nonionic surfactant include a C₁₀-C₁₂ linear alcohol with 6 moles of ethylene oxide (SURFONIC® L12-6), a C₁₀-C₁₂ linear alcohol with 8 moles of ethylene oxide (SURFONIC® L12-8), a C₁₂-C₁₄ linear alcohol with 5 moles of ethylene oxide (SURFONIC® L24-5), a C₁₂-C₁₄ linear alcohol with 7 moles of ethylene oxide (SURFONIC® L24-7), a C₁₂-C₁₄ linear alcohol with 9 moles of ethylene oxide (SURFONIC® L24-9 surfactant), a C₁₂-C₁₄ linear alcohol with 12 moles of ethylene oxide (SURFONIC® L24-12), a four-mole ethoxylate of isodecyl alcohol (SURFONIC® DA-4), a six-mole ethoxylate of isodecyl alcohol (SURFONIC® DA-6), a six-mole ethoxylate of branched isotridecyl alcohol (SURFONIC® TDA-6), an eight-mole ethoxylate of branched isotridecyl alcohol (SURFONIC® TDA-8), a nine-mole ethoxylate of branched isotridecyl alcohol (SURFONIC® TDA-9), an eleven-mole ethoxylate of branched isotridecyl alcohol (SURFONIC® TDA-11), a nine-mole ethoxylate of a C₁₂-C₁₃ branched alcohol (SURFONIC® LSF23-9),a C₉-C₁₁ alcohol with about 6 moles of ethylene oxide (EMPILAN® KR-6), a C₉-C₁₁ alcohol with about 8 moles of ethylene oxide (EMPILAa N® KR-8), a palm stearin methoxy ester ethoxylate (SURFONIC® ME530-PS, ME400-CO, ME550-SO, E400-MO), an ethoxylated and propoxylated linear primary alcohol (SURFONIC® LF-18), or a blend of ethoxylated alcohols like SURFONIC® HSC-400, HSC-420, and HDL-95. The SURFONIC® mark is owned by Huntsman Petrochemical LLC, The Woodlands, Tex., USA, and the above-mentioned SURFONIC® surfactants are available from Huntsman Petrochemical LLC.

In one embodiment, the weight ratio of the supra-amphiphile to the nonionic surfactant is such that the supra-amphiphile is substantially soluble in water. In one particular embodiment, the weight ratio of the supra-amphiphile to the nonionic surfactant is in a range of from about 1:10 to about 10:1, or from about 1:5 to about 5:1, or from about 1:4 to about 4:1, or from about 1:4 to about 1:1, or from about 1:3 to about 1:1.

In another aspect, the present disclosure is directed to a method of making a surfactant composition comprising mixing a supra-amphiphile (as described herein) and a nonionic surfactant (as described herein).

In yet another aspect, the surfactant composition is provided as an aqueous cleaning composition which can be applied directly to a soiled or stained soft or hard surface. The cleaning composition may comprise from about 0.5% by weight to about 95% by weight of the surfactant composition and from about 5% to about 99.5% by weight, based on the total weight of the cleaning composition, of water. In other embodiments, the cleaning composition may comprise from about 20% by weight to about 55% by weight, or from about 30% by weight to about 50% by weight of the surfactant composition, the % by weights being based on the total weight of the cleaning composition. In still other embodiments, the aqueous cleaning composition contains at least about 0.1% by weight, or at least about 1% by weight, or at least about 5% by weight, or at least about 10% by weight, or even at least about 15% by weight or even still at least about 20% by weight of the surfactant composition, the % by weights being based on the total weight of the cleaning composition.

In another embodiment, the surfactant composition is provided in the form of, for example, a concentrated cleaning composition, which can be subsequently diluted with water by the user to form a ready to use cleaning composition. The concentrated cleaning composition generally includes between about 5% by weight and about 90% by weight of the surfactant composition and less than about 50% by weight, or less than about 40% by weight, or even less than about 30% by weight of water. Accordingly, the cleaning composition may also be provided to the user as a ready to use cleaning composition in which the concentrated cleaning composition has already been diluted with up to about 95-99% by weight water, based on the total weight of the ready to use cleaning composition.

In addition to the surfactant composition and water, the cleaning composition may also include one or more water insoluble solvents or oils or mixtures thereof herein referred to as an oil component thereby forming a single phase microemulsion. The oil component helps form the single phase microemulsion and at the same time, may acts as a solvent or softener to remove a soil or stain from a surface. The oil component may be provided in an amount ranging between about 0.5% by weight to about 75% by weight, based on the total weight of the single phase microemulsion, or in other embodiments in an amount ranging between about 1% by weight to about 50% by weight, based on the total weight of the single phase microemulsion, and in still another embodiment in an amount ranging between about 2% by weight to about 35% by weight, and in yet another embodiment between about 3% by weight to about 25% by weight, based on the total weight of the single phase microemulsion.

In one embodiment, the oil component may include: an ether such as a glycol ether or a PPG butyl ether; a hydrocarbon or solvent, such as squalane, limonene, liquid paraffin, liquid isoparaffin, a-olefin oligomer, hexadecane, hexane, dipentene, octyl benzene, mineral spirits, mineral oil and the like; a liquid ester, such as isopropyl myristate, octyldodecyl myristate, oleyl oleate, decyl oleate, 2-hexyl decyl isostearate, hexyl decyl dimethyloctanoate, isopropyl palmitate, ethylhexyl palmitate, octyl methoxycinnamate (OMC), hexyl laurate, butyl stearate, diisopropyl adipate and the like; motor oils; a vegetable oil, such as avocado oil, canola oil, almond oil, jojoba oil, olive oil, sesame oil, sasanqua oil, safflower oil, soybean oil, castor oil, camellia oil, corn oil, rapeseed oil, rice bran oil, par chic oil, palm kernel oil, palm oil, tea tree oil, sunflower seed oil, grape seed oil, cotton seed oil, hempseed oil, lavender oil and the like; an animal oil, such as turtle oil, mink oil, egg yolk fatty oil, algae oil and the like; and silicone oils, such as dimethylpolysiloxane, methylphenyl polysiloxane, methylhydrogen polysiloxane, octamethylcyclotetrasiloxane and the like; and mixtures thereof.

In one particular embodiment, the single phase microemulsion is substantially free of alcohols. In another embodiment, the single phase microemulsion is substantially free of electrolytes. In still another embodiment, the single phase microemulsion is substantially free of alcohols and electrolytes.

In still another embodiment, the cleaning compositions herein are neutral compositions, and thus have a pH, as measured at 25° C., of from about 5 to about 9.5, or from about 6 to about 8, or from about 6.5 to about 7.5, or even about 7.

The cleaning compositions according to the present disclosure may also comprise a variety of auxiliary components depending on the technical benefit aimed for and the surface that is to be treated.

Examples of auxiliary components include antioxidizing agents, suspending aids, chelating agents, co-surfactants, radical scavengers, perfumes, cleaning and surface-modifying polymers, builders, antimicrobial agents, germicides, hydrotropes, colorants, stabilizers, bleaches, bleach activators, suds controlling agents both for suds boosting and suds suppression like fatty acids, enzymes, soil suspenders, anti-corrosion inhibitors, brighteners, anti-dusting agents, dispersants, pigments, dyes, pearlescent agents, rheology modifiers and skin care actives such as emollients, humectants and/or conditioning polymers. Levels of these auxiliary component may range from about 0.00001% by weight up to about 90% by weight, based on the total weight of the cleaning composition.

Antioxidizing agents or preservatives optionally added to the cleaning composition include compounds such as formalin, 5-chloro-2-methyl-4-isothaliazolin-one, and 2, 6-di-tert-butyl-p-cresol. Any other conventional antioxidant used in detergent compositions may also be included such as 2, 6-di-tert-butyl-4-methylphenol (BHT), carbamate, ascorbate, thiosulfate, monoethanolamine(MEA), diethanolamine, and triethanolamine. When present, these components may be included in amounts ranging from about 0.001% by weight to about 5% by weight, based on the total weight of the cleaning composition.

Corrosion inhibitors and/or anti-tarnish aids, when present, are also incorporated at low levels, for example, from about 0.01% by weight to about 5% by weight, based on the weight of the cleaning composition, and include sodium metasilicate, alkali metal silicates, such as sodium or magnesium silicate, bismuth salts, manganese salts, benzotriazoles, pyrazoles, thiols, mercaptans, aluminum fatty acid salts, and mixtures thereof.

Any optical brightener or brightening agent or bleach may be used in the cleaning compositions of the present disclosure. Typically, brightening agents, when incorporated into the cleaning compositions, are at levels ranging from about 0.01% by weight to about 1.2% by weight, based on the total weight of the cleaning composition. The brightening agents may include derivatives of stilbene, pyrazoline, coumarin, carboxylic acid, methinecyanines, dibenzothiophene-5,5-dioxide, azoles, 5- and 6-membered-ring heterocycles, and other miscellaneous agents. In addition, peroxyacid, perborate, percarbonates and chlorine bleach may be used, generally at levels ranging from about 1% by weight to about 30% by weight, based on the total weight of the cleaning composition. The bleaches may also be used in conjunction with bleach activators, such as amides, imides, esters and anhydrides and/or bleach stabilizers.

Antimicrobial agents which may be present in the cleaning composition include disinfectants such as benzalkonium chloride, polyhexamethylene biguanide, phenolic disinfectants, amphoteric disinfectants, anionic disinfectants, and metallic disinfectants (e.g. silver). Other antimicrobial agents include hydrogen peroxide, peracids, ozone, hypochloride and chlorine dioxide. The amount of antimicrobial agent which may be incorporated into the cleaning composition ranges from about 0.1% by weight to about 10% by weight, based on the total weight of the cleaning composition.

Germicides which may be included are compounds such as copper sulfate. If present, the germicide can range from between about 0.01% by weight to about 5% by weight, based on the total weight of the cleaning composition.

Any suitable organic and inorganic suspending aids typically used as gelling, thickening or suspending agents in cleaning compositions may be used herein. Organic suspending aids include polysaccharide polymers, polycarboxylate polymer thickeners, layered silicate platelets, for example, hectorite, bentonite or montmorillonites, hydroxyl-containing crystalline structuring agents such as a hydroxyl-containing fatty acid, fatty ester or fatty soap wax-like materials such as 12-hydroxystearic acid, 9, 10-dihydroxystearic acid, tri-9, 10-dihydroxystearin and tri-12-hydroxystearin, castor wax or hydrogenated castor oil. Particular polysaccharide polymers for use herein include substituted cellulose materials like carboxymethylcellulose, ethyl cellulose, hydroxyethyl cellulose, hydroxypropylcellulose, hydroxymethylcellulose; micro fibril cellulose (MFC), succinoglycan and naturally occurring polysaccharide polymers like xanthan gum, gellan gum, guar gum and its derivatives, locust bean gum, tragacanth gum, succinoglucan gum, or derivatives thereof. When present, the suspending aid may be used in amounts ranging from about 0.01% by weight to about 10% by weight, based on the total weight of the cleaning composition.

Chelating agents, if present, can be incorporated in the compositions herein in amounts ranging from about 0.01% by weight to about 10.0% by weight, based on the total weight of the cleaning composition. Examples of chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP), dihydroxydisulfobenzenes such as 1,2-dihydroxy-3,5-disulfobenzene, ethylene diamine N,Nindisuccinic acid, or alkali metal, or alkaline earth, ammonium or substitutes ammonium salts thereof or mixtures thereof, ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms, salicylic acid, aspartic acid, glutamic acid, glycine, malonic acid or mixtures thereof.

Suitable colors and fragrances are well known to those skilled in the art. Colors include Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), and Acid Green 25 (Ciba-Geigy). Examples of fragrances include natural products such as ambergris, benzoin, castoreum, civet, clove oil, galbanum, jasmine, rosemary oil, sandalwood, orange oil, lemon oil, rose extract, lavender, musk, pine oil, cedar and the like. Examples of aroma chemicals include, but are not limited to, isoamyl acetate (banana); isobutyl propionate (rum); methyl anthranilate (grape); benzyl acetate (peach); methyl butyrate (apple); ethyl butyrate (pineapple); octyl acetate (orange); n-propyl acetate (pear); and ethyl phenyl acetate (honey). The cleaning compositions according to this disclosure can contain any combination of the above types of compounds in an effective amount necessary to produce an odor masking effect or reduce an unwanted odor to an acceptable level and in some embodiments, the oils and esters listed above may be used as the oil component. The amounts used can be readily determinable by those skilled in the art and can range from about 0.01% by weight to about 5% by weight, based on the total weight of the cleaning composition.

Polymeric suds stabilizers may be selected from homopolymers of (N,N-dialkylamino) alkyl esters and (N,N-dialkylamino) alkyl acrylate esters and hydrophobically modified cellulosic polymers including methylcellulose, hydroxypropyl methylcellulose, hydroxyethyl methylcellulose, and mixtures thereof. The amount of the polymeric suds stabilizer may range from about 0.01% by weight to about 15% by weight, based on the total weight of the cleaning composition.

If desired, enzymes may be included in the cleaning composition to provide cleaning performance benefits. The enzymes, when present, range from about 0.0001% by weight to about 5% by weight of active enzyme, based on the total weight of the cleaning composition, and include one or a mixture of cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, beta-glucanases, and arabinosidases.

When enzymes are present, enzyme stabilizers may also be included in the cleaning compositions in an amount ranging from about 0.001% by weight to about 10% by weight of total weight of the cleaning composition. Enzyme stabilizers are compounds that are compatible with the enzymes and include calcium ion, boric acid, propylene glycol, short chain carboxylic acids, boronic acids, and mixtures thereof. For example, boric acid salt, such as an alkali metal borate or amine (e.g. an alkanolamine) borate, or an alkali metal borate, or potassium borate, calcium chloride, calcium hydroxide, calcium formate, calcium malate, calcium maleate, calcium hydroxide and calcium acetate are enzyme stabilizers which may be used in the cleaning compositions of the present invention

To make the compositions herein, the components above are combined together by means well known in the art. The relative levels of the components are selected to give the required performance of the composition in a hard surface or soft surface cleaning application, with an eye toward making sure on the one hand that a component is present at a sufficient level to be effective, but on the other hand that excessive cost is avoided by limiting the upper range of the component.

Because the compositions herein are generally prepared as liquid formulations, the compositions may be easily prepared in any suitable vessel or container. The order of mixing the components is not particularly important and generally the various components can be added sequentially or all at once in the form of aqueous solutions.

Once formulated, the compositions of the present disclosure can be packaged in a variety of containers such as steel, tin, or aluminum cans, plastic or glass bottles and paper or cardboard containers.

The cleaning compositions of the present disclosure may be used in a variety of applications and in one particular embodiment are especially suitable for cleaning hard surfaces or soft surfaces.

Thus, in another aspect, the present disclosure provides a method of removing a soil or stain from a hard surface or soft surface. A standard means of treatment is to contact or apply the cleaning composition according to the present disclosure to or against a hard surface or soft surface in a variety of application means, for example, spraying, such as in aerosol form or by standard spray nozzles, rubbing, scraping, brush application, dipping, coating, application in gel form, or pouring the cleaning composition on or against the hard surface or soft surface. The cleaning composition may then be removed from the hard surface or soft surface by rinsing with water and/or wiping until the cleaning composition is no longer visible to the eye. The hard or soft surface may also be air-dried to remove the cleaning composition or remaining water from the surface.

While the surfactant compositions are especially useful in cleaning compositions, they have also been found to be highly versatile and may be included in aqueous compositions or microemulsions for use in cosmetic and dermatological applications.

Thus, in another embodiment, there is a provided a personal care composition comprising the surfactant composition of the present disclosure and water. “Personal care” relates to compositions to be topically applied to a person's hair or skin, but not ingested orally. Preferably, the personal care compositions are to be topically applied to a person's skin during rinse-off applications. Contemplated are personal care compositions comprising the surfactant composition which include body-washes, shower gels, exfoliating compositions, shampoos, rinse-off conditioners, shaving foams, face washes, cleansers, hand washes, cleansing creams/milks, astringent lotions, skin toners or fresheners, bubble baths, soluble bath oils, and bar soaps.

According to some embodiments, the personal care composition comprises 0.001% by weight or greater, optionally 0.01% by weight or greater, or 0.02% by weight or greater or 0.1% by weight or greater, or 0.5% by weight or greater, or 1% by weight or greater of the surfactant composition, where the % by weight is based on the total weight of the personal care composition. In another embodiment, the personal care composition comprises 10% by weight or less, or 5% by weight or less, of the surfactant composition, where the % by weight is based on the total weight of the personal care composition.

Other components (and their amounts) which may be included in the personal care composition are well known to those skilled in the art and may include those listed above. For example, other components that may be included are a humectant, a preservative, a pH adjuster, a moisturizer and/or an anti-irritant, such as aloe vera, PEG-7 glyceryl cocoate, Chamomile, avocado oil or sweet almond oil, a dye or a perfume.

### Examples

Examples are provided below. However, the present disclosure is to be understood to not be limited in its application to the specific experiments, results, and laboratory procedures disclosed herein below. Rather, the Examples are simply provided as one of various embodiments and are meant to be exemplary and not exhaustive.

To demonstrate the limited solubility of amine salts having gemini-like and/or oligomeric-like structures, an aqueous solution comprising 10 wt. % low 2-phenyl LAS was titrated with different amounts of ethylene diamine (“EDA”) such that the pH of the solution rose from 2 to 10. At a mole ratio near 0.5 of EDA to low 2-phenyl LAS (i.e., one mole of EDA to two moles of low 2-phenyl LAS), an approximately neutral pH was achieved and a gemini-like surfactant is formed as partially evidenced by the formation of a salt precipitate. The salt precipitate persisted from a mole ratio of from about 0.5 to about 0.8, the solution for such having a pH ranging from about 5 to about 9.5. Continuing to increase the mole ratio of EDA to low 2-phenyl LAS beyond 0.8 eventually causes the gemini-like and/or oligomeric-like salts to be lost and result back in soluble monomeric surfactant structures. FIG. 2 illustrates the effect of mole ratio of the EDA to low 2-phenyl LAS on the formation of gemini-like and/or oligomeric-like surfactants and the solubility of such.

To overcome the limited solubility of amine salts having gemini-like and/or oligomeric-like structures, additional surfactants were added to aqueous solutions of amine salts having the gemini-like and/or oligomeric-like structures.

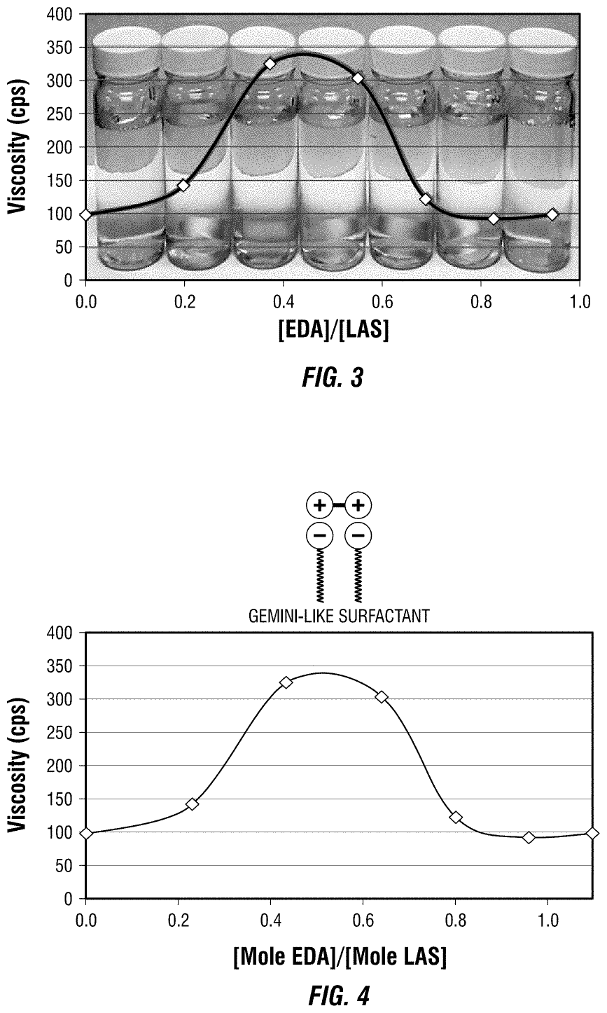

In one specific example, an aqueous solution of 7.5 wt. % nonionic surfactant (i.e., C₁₂-C₁₄ linear alcohol with 7 moles of ethylene oxide, commercially available as SURFONIC® L24-7 from Huntsman Corp. or an affiliate thereof, The Woodlands, Tex., USA) and 2.5 wt. % low 2-phenyl LAS was titrated with ethylene diamine (“EDA”) as shown in FIG. 3. The combination of the nonionic surfactant and salt of EDA and low 2-phenyl LAS was unexpectedly found to (i) be soluble in the aqueous composition at room temperature (i.e., about 20° C.) regardless of the mole ratio of EDA to 2-phenyl LAS (as shown in FIG. 3), and (ii) retain the beneficial physical properties of the gemini-like surfactants as demonstrated by the viscosity curve showing that the solution has a significant increase in viscosity (up to 350%) when the mole ratio of ethylene diamine to LAS was in the range for forming a gemini-like surfactant (as shown in FIG. 4).

Additional examples were prepared as described above by individually titrating each of the following (poly)ethylene polyamines: EDA, DETA, TETA, and TEPA into an aqueous solution of 7.5 wt. % nonionic surfactant (SURFONIC® L24-7 surfactant) and 2.5 wt. % low 2-phenyl LAS. For each example, the EDA, DETA, TETA, or TEPA was separately combined with the aqueous solution of 2.5 wt. % low 2-phenyl LAS and 7.5 wt. % SUROFNIC® L24-7 until a substantially neutral pH was reached.

A comparative example comprising the monofunctional amine of monoethanolamine (MEA) was also prepared to demonstrate the difference in physical properties (e.g., viscosity) of the multifunctional amine compositions that are able to form gemini-like or oligomeric like surfactants and monofunctional amines, which are not. The comparative example was prepared by individually titrating MEA into an aqueous solution of 7.5 wt. % nonionic surfactant (SURFONIC® L24-7 surfactatn) and 2.5 wt. % low 2-phenyl LAS.

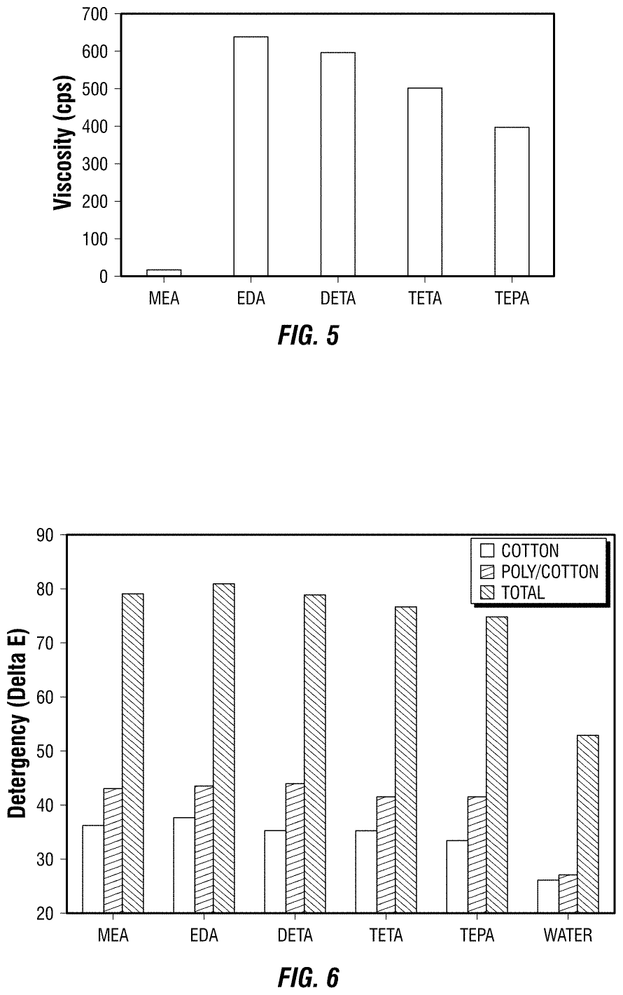

The viscosities of the above-described MEA, EDA, DEA, TETA, and TEPA solutions were measured using a Brookfield viscometer with RV/HA/HB spindles, the results for which are presented in FIG. 5. As shown in FIG. 5, compared to MEA, all of the multifunctional amine-containing formulations build considerable viscosity at low surfactant actives. The ability to build viscosity at low surfactant actives is an important criteria for liquid laundry detergents.

The detergency of the above-noted MEA, EDA, DETA, TETA, and TEPA solutions comprising 2.5 wt. % low-phenyl LAS and 7.5 wt. % SURFONIC® L24-7 was tested in a 6 pot terg-o-tometer under standard U.S. wash conditions. Dirty motor oil, dust sebum, olive oil, and clay on cotton and polyester-cotton blends were washed in 200 ppm concentrations of the above-described MEA, EDA, DETA, TETA, and TEPA formulations at 40° C. and 150 ppm water hardness. The optical reflectance of the soil swatches was measured before and after washing. All soil/swatch combinations were washed in triplicate and the results in Delta E units was averaged. The cleaning results are shown in FIG. 6. As demonstrated in FIG. 6, the experimental compositions all performed significantly better than water and were comparable to the single functional amine found in common detergents but with the added advantage that the experimental compositions have a significantly increased viscosity at lower levels of surfactant actives, which as previously mentioned, is an important property for liquid laundry detergents.

From the above description, it is clear that the present disclosure is well adapted to carry out the object and to attain the advantages mentioned herein as well as those inherent in the present disclosure. While exemplary embodiments of the present disclosure have been described for the purposes of the disclosure, it will be understood that numerous changes may be made which will readily suggest themselves to those skilled in the art which can be accomplished without departing from the scope of the present disclosure and the appended claims.

1. A surfactant composition comprising (i) a nonionic surfactant, and (ii) a supra-amphiphile.

2. The surfactant composition of claim 1, wherein the supra-amphiphile is a salt of a multi-functional amine and an anionic surfactant.

3. The surfactant composition of claim 2, wherein the multifunctional amine is selected from a (poly)ethylene polyamine, a (poly)propylene polyamine, or a combination thereof.

4. The composition of claim 2, wherein the multifunctional amine is a (poly)ethylene polyamine selected from ethylene diamine, diethylene triamine, triethylene tetramine, tetraethylene pentamine, or combinations thereof.

5. The surfactant composition of claim 2, wherein the anionic surfactant is selected from linear alkylbenzene sulfonates, alkyl ether sulfates, alkyl sulfates, secondary alkane sulfonates, olefin sulfonates, sulfosuccinates, phosphate esters, soaps, or combinations thereof.

6. The surfactant composition of claim 2, wherein the anionic surfactant is a linear alkylbenzene sulfonate.

7. The surfactant composition of claim 2, wherein the mole ratio of the multi-functional amine to the anionic surfactant is such that the composition has a pH in a range of from about 5 to about 9.5.

8. The surfactant composition of claim 2, wherein the mole ratio of the multi-functional amine to the anionic surfactant is such that the composition has a pH in a range of from about 6 to about 8.

9. The surfactant composition of claim 1, wherein the supra-amphiphile is a salt of a cationic surfactant and a multi-functional acid.

10. The surfactant composition of claim 9, wherein the mole ratio of the multi-functional acid and cationic surfactant is such that the composition has a pH in a range of from about 5 to about 9.5.

11. The surfactant composition of claim 1, wherein the composition has a pH in a range of from about 6 to about 8.

12. The surfactant composition of claim 1, wherein the nonionic surfactant is selected from nonylphenol ethoxylates, fatty alcohol ethoxylates, methyl ester ethoxylates, alkyl polyglucosides, alkanolamide, vegetable oil ethoxylates, or a combination thereof.

13. The surfactant composition of claim 1, wherein the nonionic surfactant has a hydrophile-lipophile balance of 10 to 14.

14. The surfactant composition of claim 1, wherein the weight ratio of the supra-amphiphile to the nonionic surfactant is in a range of from 1:10 to 10:1.

15. The surfactant composition of claim 1, wherein the composition is substantially soluble in an aqueous solution.

16. A method of making the surfactant composition of claim 1, comprising mixing (i) a supra-amphiphile, and (ii) a nonionic surfactant.

17. The method of claim 16, wherein the supra-amphiphile is present in an aqueous solution.

18. An aqueous cleaning composition comprising (i) water, and (ii) the surfactant composition claim 1.

19. The aqueous cleaning composition of claim 18, wherein the surfactant composition is present at a concentration in a range of from 0.01 to 95 weight percent of the aqueous cleaning composition.

20. The aqueous cleaning composition of claim 18, wherein the aqueous cleaning composition is substantially free of any additional surfactants.
